(19) United States
(12) Patent Application Publication
(10) Pub. No.: US 2013/0238500 A1
(43) Pub. Date: Sep. 12, 2013

(54) ONLINE MERCHANT EXPRESS PAYMENT USING A DYNAMIC TIME-DEPENDENT PASSCODE GENERATOR

(71) Applicant: Cary E. Moore, Houston, TX (US)

(72) Inventor: Cary E. Moore, Houston, TX (US)

(73) Assignee: BANK OF AMERICA CORPORATION, Charlotte, NC (US)

(21) Appl. No.: 13/416,917

(22) Filed: Mar. 9, 2012

(51) Int. Cl. G06Q 20/40

(52) U.S. Cl. 705/44

(57) ABSTRACT

The invention provides for accelerating online merchant transactions through the use of a dynamically generated time-dependent passcode. The transaction is conducted by the customer inputting only the passcode and, in some instances, a payment account identifier, which are communicated from the merchant to the payment processing entity. The payment processing entity uses the passcode to authenticate the customer, authorizes the transaction and communicates the customer's personal information back to the online merchant. The transaction is completed upon the customer confirming the personal information, in the form of name, shipping address, billing information/address and the like. Both the customer and the online merchant benefit from an express online transaction that can be completed in a simple and efficient manner and affords heightened security.

### FIELD

In general, embodiments of the invention relate to electronic commerce (i.e., e-commerce) and, more particularly, expedited online merchant transaction payment using a dynamic time-dependent passcode generator.

### BACKGROUND

Internet-based merchants, otherwise referred to as online merchants, realize that time is of the essence when it comes to online transactions. Research has shown that all too often online customers will initiate transactions with online merchants, such as by placing items in a virtual shopping cart or the like, but will fail to complete the transaction. From the customer perspective the reasons for failing to complete the transaction may vary. In some instances, the transaction may be characterized as an impulse purchase and, as such, the more time that the customer has to question the need for the purchase the less likely the transaction will actually occur. In other instances, the customer may be reluctant to complete a transaction due to the complexity and/or time associated with completing the check-out process. In still further instances, a customer may be reluctant to initiate a transaction with an online merchant, let alone complete the transaction, due to concerns over the security of an online merchant, especially if the online merchant is not a well-known merchant or has been susceptible to past instances of misappropriate of identity.

Most online merchants provide customers the capability to create customer accounts. Customer accounts provide the customer the ability to store personal information, such as name, shipping address, billing information/account, billing address and the like, in a merchant's customer database for the purpose of adding efficiency to future transactions conducted by the customer. For example, a customer logs-in to their customer account, initiates a transaction with the merchant, and the personal information in the customer account is automatically retrieved from the database and used to complete the transaction. While such customer accounts have gained acceptance amongst many online customers, the recent rash of high-profile site-wide misappropriation of identities have led many customers to question the need to have their personal information stored with a merchant.

However, from an online merchant perspective, the use of customer account information not only makes for a more efficient transaction, but also insures that the customer information is accurate. Accurate customer information, such as name, billing information and billing address, is needed to insure that the transaction is approved by the payment processor. However, equally important is the accuracy of the shipping information, which insures that the items purchased are properly received by the customer. Problems related to inaccurate shipping addresses plague online merchants since an inaccurate shipping address may result in the merchant being forced to either re-ship the items and incur additional shipping costs or, in the event that the merchant attempts to charge the additional shipping to the customer, run the risk of the order/transaction being cancelled by the customer.

Therefore, a need exists to develop improvements in online transaction processing. From the customer perspective, the desired online transaction processing should result in a highly efficient and simplistic check-out process that allows the customer to conduct the transaction as quickly as possible. Moreover, and equally as important, the desired online transaction processing should provide the customer with a highly secure online transaction process, which does not require that the customer maintain a customer account with the online merchant. From the online merchant perspective, a high velocity check-out process insures the merchant that transactions which are initiated by a customer are subsequently processed through completion. In addition, the desired online transaction processing should provide the merchant with vetted customer shipping information, insuring that the items purchased are correctly shipped to the customer's desired shipping address.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program products, or a combination of the foregoing for an expedited online merchant payment system using a dynamic time-dependent passcode generator, otherwise referred to as a one-time passcode (OTP) generator, such as an RSA SecureID passcode generator or the like. The dynamic time-dependent passcode generator, which may be embedded in a credit, debit or stand-alone card, a fob or the like, is provided to the customer as a security ‘token’ and, upon customer activation, generates a time-dependent passcode that is valid for a short period of time (e.g., one minute) and typically limited to a single use. The passcode generator is synchronized in time with an algorithm executing at the payment processing site, which allows for the transaction to be authenticated based on receipt of the passcode generated by the customer being in synch with the passcode generated by the payment processing entity, e.g., financial institution or the like.

In the present invention, an online transaction can be completed solely in response to the customer providing the passcode generated by the dynamic time-dependent passcode generator and, in some embodiments, a payment account identifier (e.g., a credit/debit card number or some other identifier associated with the payment account). The online merchant communicates the passcode and, in some embodiments, the payment account identifier to the payment processing entity, which in turn authenticates the customer/transaction, authorizes the transaction and provides the online merchant with the customer's personal information needed to complete the transaction (e.g., name, shipping address, billing address, telephone number, email address and the like). The customer is presented with a display of their requisite personal information and upon confirmation of the information, or customer changes to the information, the transaction is deemed to be completed.

By limiting the amount of information that is needed to be inputted by the customer to the dynamic time-dependent passcode and, in some embodiments, the payment account identifier, both the customer and the online merchant benefit from an express payment transaction that can be completed in a simple and efficient manner. Additionally, the online payment processing described herein provides a heightened level of security to the customer, in that another party would need to be in possession of the payment account identifier and the associated dynamic time-dependent passcode generator to attempt to wrongfully complete a transaction. In addition, according to specific embodiments of the invention, the customer is not required to have an account with the online merchant, thereby, limiting their online exposure and lessening the likelihood of identity misappropriation. Moreover, the online merchant benefits from the payment processing entity providing the online merchant with vetted customer information, thereby, insuring that the shipping information is accurate.

A method for processing an online transaction conducted with an online merchant defines first embodiments of the invention. The method includes receiving an online payment request associated with the transaction. The request includes customer-inputted data consisting of a dynamically-generated time-dependent passcode. In alternate embodiments, the customer inputted data may consist of a payment account identifier and the dynamically-generated time-dependent passcode. The method further includes authenticating the transaction by verifying an association between the dynamically-generated time-dependent passcode and a payment account and, in response to successfully authenticating the transaction, retrieving customer-specific transaction processing data associated with the payment account. In addition the method includes communicating transaction authorization and the customer-specific transaction processing data to the online merchant. The customer-specific transaction processing data is configured to populate data fields in an online check-out form associated with the transaction.

In specific embodiments of the method, in which the customer-inputted data consists of the payment account identifier and the dynamically-generated time-dependent passcode, the payment account identifier may take the form of a credit card number or a debit card number.

In alternate related embodiments of the method, in which the customer-inputted data consists of the payment account identifier and the dynamically-generated time-dependent passcode, the payment account identifier may take the form of at least a username or password. In such embodiments of the method, the username, the password or both may be linked to the payment account. In other related embodiments of the method, the username, the password or both may be associated with a customer account at the online merchant and the customer account provides for the payment account. In still further related embodiments of the method, the username, the password or both are associated with a mobile banking service account that provides for the payment account.

In other related embodiments of the method, the customer-specific transaction processing data is further defined as including at least a customer name, a shipping address and a billing address.

A system for processing an online transaction conducted with an online merchant defines second embodiments of the invention. The system includes a dynamic passcode generator device configured to generate a dynamic time-dependent passcode. In addition the system includes a computing device, for example, a server device associated with a financial institution, which includes a memory and a processor. Additionally, the system includes a payment processing module stored in the memory of the computing device and executable by the processor. The module is configured to receive an online payment request that includes customer-inputted data consisting of the dynamic time-dependent passcode, and, in some embodiments, the dynamic time-dependent passcode and a payment account identifier. The module is further configured to authenticate the transaction by verifying an association between the dynamically-generated time-dependent passcode and a payment account and, in response to successfully authenticating the transaction, retrieve customer-specific transaction processing data associated with the payment account. In addition, the module is configured to communicate transaction authorization and the customer-specific transaction processing data to the online merchant. The customer-specific transaction processing data, which may be the customer's name, shipping address, billing information, billing address, and the like, is configured to populate data fields in an online check-out form associated with the transaction.

In alternate embodiments of the system, in which the customer-inputted data consists of the payment account identifier and the dynamically-generated time-dependent passcode, the payment account identifier is one of a credit card number or a debit card number.

In other alternate embodiments of the system, in which the customer-inputted data consists of the payment account identifier and the dynamically-generated time-dependent passcode, the payment account identifier may be at least one of a username or a password. In such embodiments of the system, the username, a password, or both may be linked to the payment account. For example, in one specific embodiment of the system, the username and/or password are associated with a customer account at the online merchant and the customer account includes the customer's payment account data, such as account number or the like. In another specific embodiment of the system, the username and/or password are associated with the customer's mobile banking service account and the mobile banking service account includes the customer's payment account information, such as account number or the like.

In further specific embodiments of the system, the dynamic time-dependent passcode generator device is embedded within a card. The card may be a stand-alone passcode generator or the card may also incorporate a payment device, such as a credit or debit card. In further specific embodiments of the system, the dynamic time-dependent passcode generator may be security token, such as a key fob or the like.

A computer program product defines third embodiments of the invention. The computer program product includes a non-transitory computer-readable medium having computer-executable instructions. The instructions cause a computer to implement the (1) receiving an online payment request associated with the transaction, wherein the request includes customer-inputted data consisting of a payment account identifier, (2) authenticating the transaction by verifying an association between the dynamically-generated time-dependent passcode and a payment account, (3) in response to successfully authenticating the transaction, retrieving customer-specific transaction processing data associated with the payment account and (4) communicating transaction authorization and the customer-specific transaction processing data to the online merchant. The customer-specific transaction processing data is configured to populate data fields in an online check-out form associated with the transaction.

Thus, systems, methods, and computer program products herein described in detail below provide for an expedited process for online merchant transactions using a dynamically generated time-dependent passcode. By only requiring that the passcode and, in some embodiments, an account identifier be inputted by the customer to initiate and complete the transaction, both the customer and the online merchant benefit from an express payment transaction that can be completed in a simple and efficient manner. Additionally, the process for online merchant transactions herein described provides a heightened level of security to the customer, in that authentication requires actual possession of both the payment account identifier and the associated dynamic time-dependent passcode generator. In addition, the customer is not required to have an account with the online merchant, thereby, limiting their online exposure and lessening the likelihood of misappropriation of identity. The online merchant benefits from the payment processing entity providing the online merchant with vetted customer information, such as shipping information, which lessens the possibility of errors in the shipping process.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram illustrating a system for express payment of online transactions using a dynamic time-dependent passcode generator, in accordance with embodiments of the present invention;

FIG. 2A provides a plan view of a credit/debit card with an embedded dynamic time-dependent passcode generator, in accordance with present embodiments of the invention;

FIG. 2B provides a plan view of a credit/debit card with an embedded dynamic time-dependent passcode generator, in accordance with present embodiments of the invention;

FIG. 3 provides a flow diagram of a method for express payment of an online transaction using a dynamic time-dependent passcode generator in which the customer 20 inputs are limited to the passcode and the payment account number, in accordance with embodiments of the present invention;

FIG. 4 provides a flow diagram of a method for express payment of an online transaction using a dynamic time-dependent passcode generator in which the customer 20 inputs are limited to the passcode and the payment account identifier, in accordance with embodiments of the present invention;

FIG. 5 provides a flow diagram of a method for express payment of an online transaction using a dynamic time-dependent passcode generator in which the customer input is limited to the passcode and the passcode is correlated to the payment account at the payment processing entity, in accordance with an embodiment of the present invention;

FIG. 6 provides a flow diagram of a method for express payment of an online transaction using a dynamic time-dependent passcode generator in which the customer input is limited to the passcode and the passcode is correlated to the payment account based on a customer account with the online merchant, in accordance with an embodiment of the present invention; and

FIG. 7 provides a flow diagram of a method for express payment processing using a dynamic time-dependent passcode, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as a system, a method, a computer program product, and/or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods, systems, computer program products or the like. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, a high velocity online merchant payment system that implements a dynamic time-dependent passcode generator is described. As previously noted, the dynamic time-dependent passcode generator is also commonly referred to as a one-time passcode (OTP) generator, such as an RSA SecureID passcode generator or the like. The dynamic time-dependent passcode generator may be embedded in a credit, debit or stand-alone card, or a security token, such as a key fob or the like. Upon customer activation the passcode generator generates a time-dependent passcode that is valid for a short period of time (e.g., one minute) and typically limited to a single use. The passcode generator is synchronized in time with an algorithm executing at the payment processing site, which allows for the customer to be authenticated based on receipt of the passcode by the payment processing entity, e.g., financial institution or the like and verification that the passcode matches the synchronized passcode.

In the present invention, an online payment transaction is conducted solely in response to the customer providing the passcode generated by the dynamic time-dependent passcode generator and, in some embodiments, a payment account identifier (e.g., a credit/debit card number or some other identifier associated with the payment account). In this regard, the customer is not required to have a previous relationship with the online merchant (e.g., an established customer account) nor is the customer required to provide any additional personal information (e.g., name, shipping address, billing information/address, email address telephone number or the like) beyond the passcode and payment account identifier.

In practice, the online merchant communicates the passcode and, in some embodiments, the payment account identifier to the payment processing entity, which in turn authenticates the customer, authorizes the transaction and provides the online merchant with the customer's personal information needed to complete the transaction (e.g., name, shipping address, billing address/information, telephone number, email address and the like). The customer is presented with a display of their requisite personal information and upon confirmation of the information, or changes to the information, the transaction is deemed to be completed.

In accordance with embodiments of the invention, both the customer and the online merchant benefit from a high velocity transaction that can be completed in a simple and efficient manner. Additionally, the online payment processing described herein provides a heightened level of security to the customer, in that another party would need to be in possession of the payment account identifier and the associated dynamic time-dependent passcode generator to attempt to wrongfully complete a transaction. In addition, since the customer is not required to have an account with the online merchant, the customer limits their online exposure and lessens the likelihood of identity misappropriation. Moreover, the online merchant benefits from the payment processing entity providing the online merchant with vetted customer information, thereby, insuring that the shipping information is accurate.

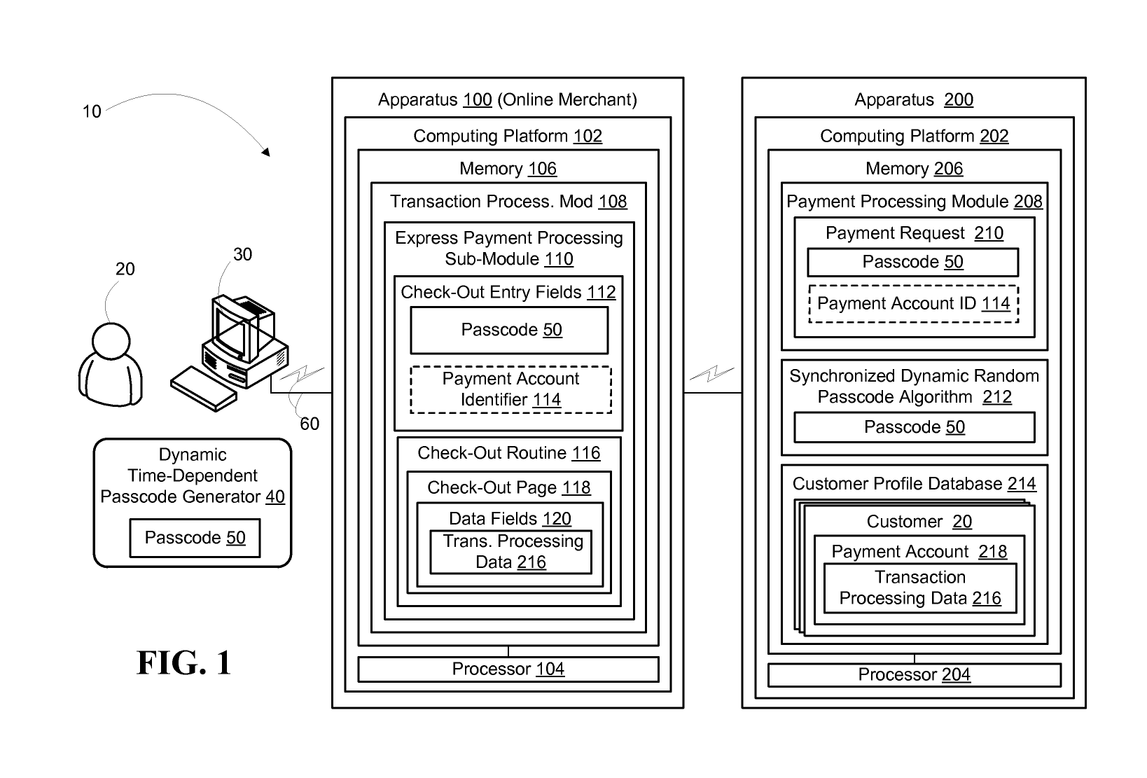

Referring to FIG. 1 a block diagram is depicted of a system 10 configured for high velocity online transactions, in accordance with embodiments of the present invention. A customer 20 interfaces with an online merchant via a computing device 30. While FIG. 1 depicts the computing device 30 as being a Personal Computer (PC), the computing device 30 may be any computing device that provides for a wired or wireless connection 60 to the Internet, such as a laptop computer, mobile communication device, tablet computer or the like. In addition, the customer 20 is in possession of a dynamic time-dependent passcode generator 40, otherwise referred to in the art as a one-time passcode (OTP)/word generator, such as an RSA secure ID passcode generator or the like. The dynamic time-dependent passcode generator 40 will, upon activation, generate a passcode 50 that is valid for a short-period of time (e.g., one minute) and currently valid, but not limited to, a single transaction/authentication. The dynamic time-dependent passcode generator 40 is synchronized with an algorithm 212 executing at the payment processing entity, e.g., a financial institution or the like, such that the customer-generated passcode 50 can be authenticated upon submission to the payment processing entity.

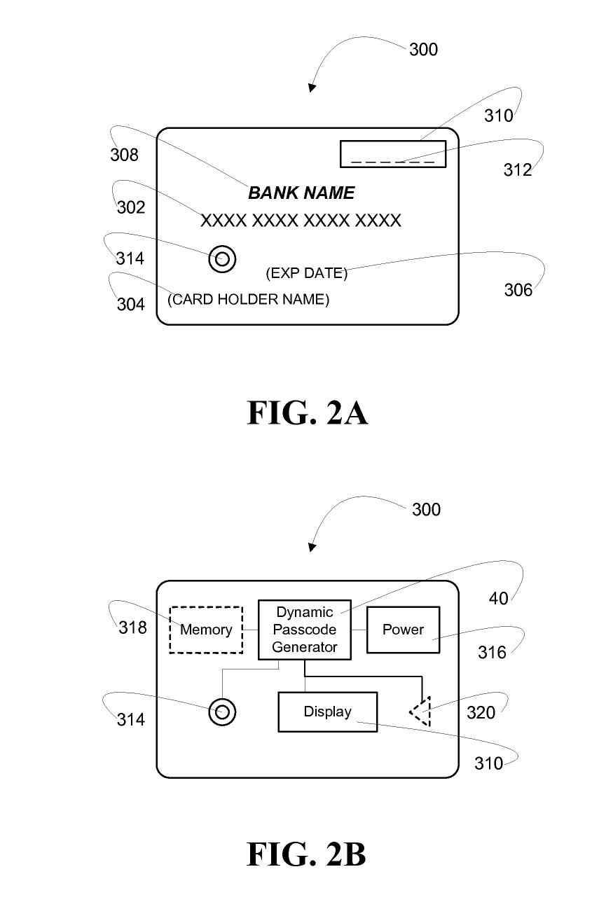

The dynamic time-dependent passcode generator 40 may take one of various forms, for example, the passcode generator 40 may be embedded within a credit/debit card, embedded with a stand-alone card, a security token (e.g., a key fob) or the like. FIGS. 2A and 2B, discussed infra, provide one example of a dynamic time-dependent passcode generator 40 embedded in a credit/debit card (300 of FIGS. 2A and 2B).

The system additionally includes apparatus 100, such as a server or the like implemented by an online merchant/retailer. The apparatus 100 includes a computing platform 102 having a processor 104 and a memory 106 in communication with the processor 104.

The memory 106 of apparatus 100 stores transaction processing module 108 that is configured to present the customer 20 various payment options and process the transaction, accordingly. Included within the payment options is express payment processing sub-module 110 which is configured to provide the customer 20 with the option of paying in a high velocity manner using their dynamic time-dependent passcode generator 40. Thus, the express payment processing sub-module 110 may be configured such that an activatable link (i.e., button or the like) indicating the express payment option is displayed on each item selection page of the online merchant's website and/or an activatable link (i.e., button or the like) indicating the express pay option is displayed on the composite check-out form/page of the online merchant's website. Upon activation of the link, the customer 20 is presented with an express pay check-out form that includes the required check-out entry fields 112. In accordance with specific embodiments of the invention the check-out entry fields 112 may consist of a passcode field for customer entry of the dynamically-generated time-dependent passcode 50. In accordance with other specific embodiments of the invention the check-out fields 112 may consist of a passcode field for entry of the dynamically-generated time-dependent passcode 50 and one or more payment account identifier fields for entry of the payment account identifier 114.

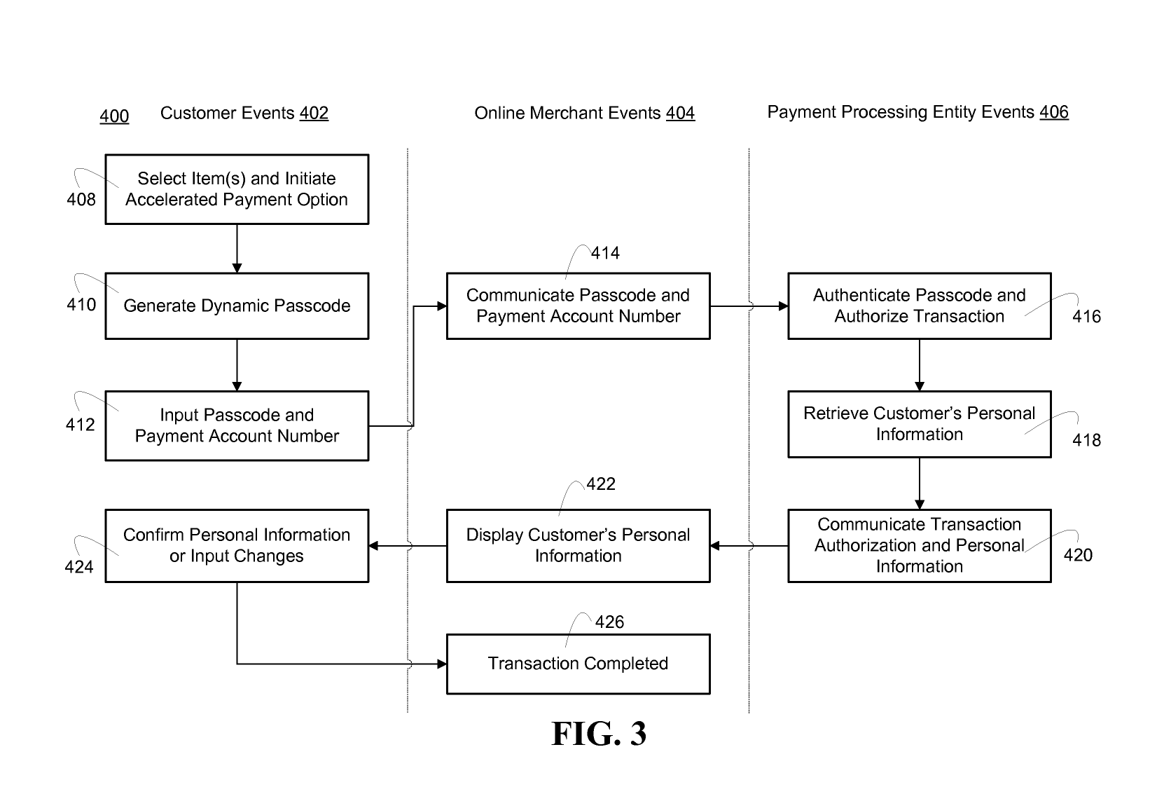

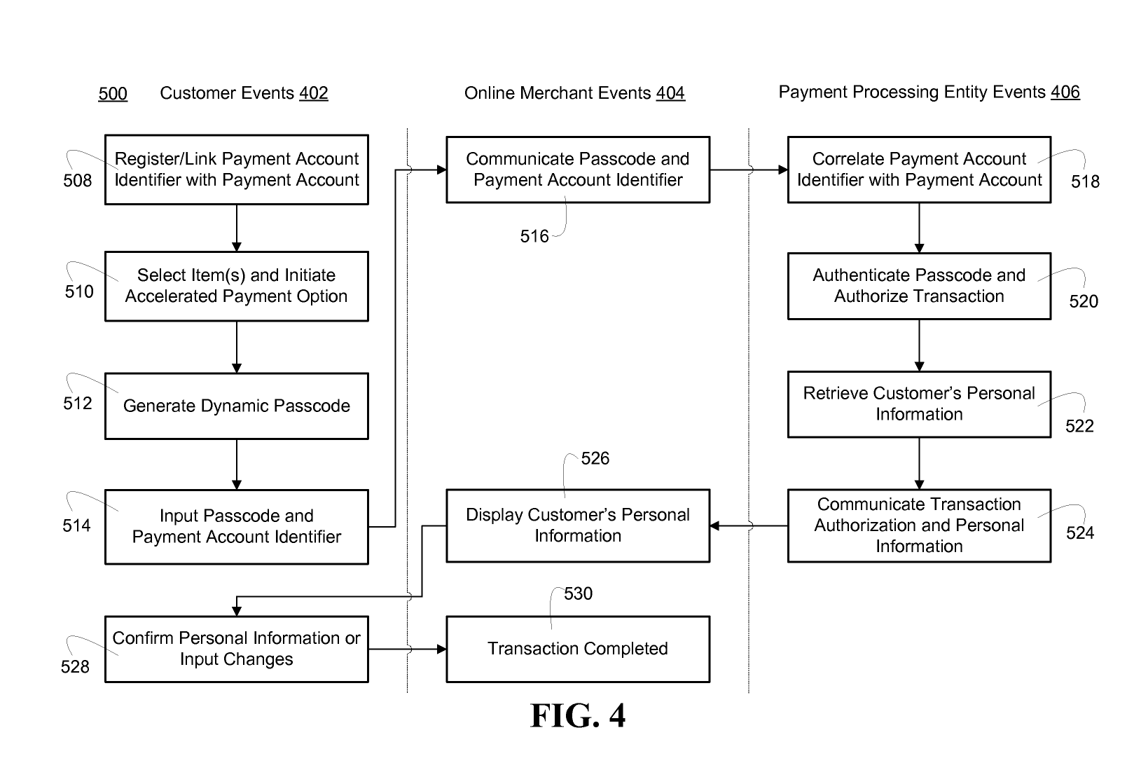

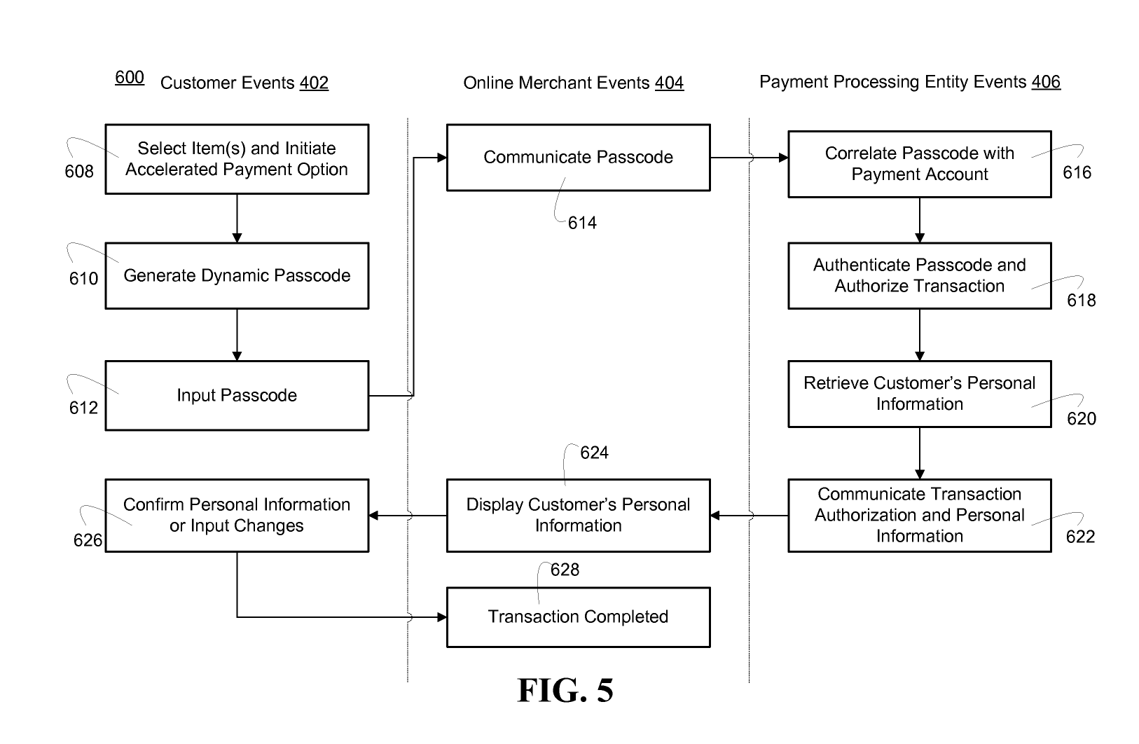

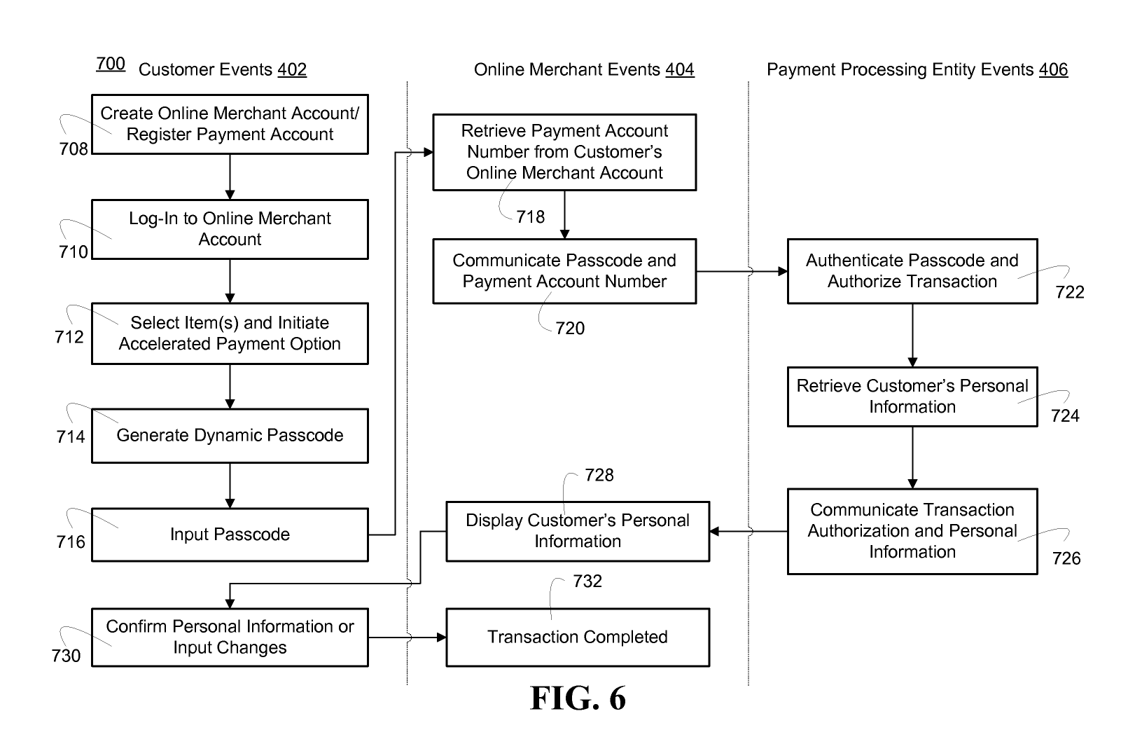

In specific embodiments of the invention, the required customer inputted data is limited to the dynamically-generated time dependent passcode 50. For example, in those embodiments in which the payment processing entity (e.g., a financial institution) has the capability to correlate a passcode 50 to the customer's payment account, the customer 20 is only be required to input the passcode 50 (see for example FIG. 5 and the related discussion, infra.). In other embodiments in which the customer 20 has previously logged-in to a customer account with the online merchant and the passcode 50 is linked within the customer account to a payment account, the customer 20 may only be required to input the passcode 50 (see for example FIG. 6 and the related discussion, infra.). In other specific embodiments of the invention, the required customer inputted data is limited to the dynamically-generated time dependent passcode 50 and a payment account identifier 114. For example, the required customer inputted data is the dynamically-generated time dependent passcode 50 and a payment account number for example, a credit or debit card number (see for example FIG. 3 and the related discussion, infra.). In other embodiments, the payment account identifier 114 is a username and/or password in which the online merchant or the payment processing entity (e.g., a financial institution) has the capability to correlate the username and/or password to a customer account and the customer's payment account is linked to the customer account. (See for example FIG. 4 and the related discussion, infra.). For example, the payment account identifier 114 may be the customer's online banking username and password, which the payment processing entity is capable of implementing to access the customer's mobile banking account and determine the linked payment account.

Referring again to FIG. 1, system 10 additionally includes apparatus 200, such as a server or the like implemented by a payment processing entity, such as a financial institution/bank or the like. The apparatus 200 includes a computing platform 202 having a processor 204 and a memory 206 in communication with the processor 204.

The memory 206 of apparatus 200 stores payment processing module 208 that is configured to receive a express payment request 210 from the online merchant (apparatus 100), in which the request includes the customer-inputted data consisting of either the dynamically-generated time-dependent passcode 50 or the passcode 50 and payment account identifier 114. The payment processing module 208 authenticates the transaction as being associated with the customer 20 by verifying that the passcode 50 is the same synchronized passcode 50 generated by the synchronized dynamic time-dependent passcode algorithm 212.

Once the transaction has been successfully authenticated, the payment processing module 208 accesses the customer profile database 214 to retrieve transaction processing data 216 associated with the customer 20 and linked to the payment account 218 identified by the payment account identifier 114. The transaction processing data 216 may be any customer-specific data required to process the transaction, such as, but not limited to, customer name, shipping address, billing address, billing information, email address, telephone number(s), age verification and the like. Once the transaction processing data 216 has been retrieved, transaction authorization and the transaction processing data 216 are communicated to the online merchant (apparatus 100).

Thus, the express payment processing sub-module 110 additionally includes a check-out routine 116 having a check-out page 118 with numerous data fields 120, such as check-out data fields 120 for customer name, shipping address, billing address, email address and the like. Upon receipt of the transaction processing data 216, the express check-out routine 116 populates the requisite data fields 120 with the information included in the transaction processing data 216. If the customer 20 is in agreement with the transaction processing data 216, the customer 20 confirms the data via activation of an associated link button on the check-out page 118 or makes requisite changes, such as changing the shipping address or the like, and then confirms the data via activation of an associated link button on the check-out page 118. Confirmation of the transaction processing data 216 completes the transaction.

As such, in accordance with embodiments of the present invention express payment is realized by the customer inputting minimal information (i.e., either the dynamically-generated passcode 50 or the passcode 50 and a payment account identifier 114), which upon receipt by the payment processing entity, results in the payment processing entity retrieving and communicating to the online merchant the customer's transaction processing data 216 (e.g., name, shipping address, billing address/information and the like). The customer's transaction processing data 216 is populated in the express payment check-out page 118/form, such that the customer 20 only needs to make further inputs if the transaction processing data 216 requires changes. Otherwise the customer 20 confirms the data and the transaction are completed.

Referring to FIGS. 2A and 2B, schematic diagrams are provided of one example of a dynamic time-dependent passcode generator 40 embedded in a credit/card debit card 300. As previously noted the passcode generator 40 may take the form of a stand-alone card (i.e., a card without credit/debit functionality), a fob, another security token or the like. For a more comprehensive teaching of a dynamic time-dependent passcode generator 40 embedded in a credit/card debit card and authenticating transaction using the passcode, see United States Patent Publication No. 2006-0242698 A1, published Oct. 26, 2006 in the name of Inskeep et. al. and assigned to the same inventive entity as the present invention. The contents of which are herein incorporated by reference as if set forth fully herein.

The credit/debit card 300 is typically a laminated plastic card having the size and shape of a conventional credit card. Conventional credit cards are approximately 3 and ⅜ inches in length and 2 and ⅛ inches in width. Smaller credit/debit cards are also known, for example, a “mini” card is approximately 2 and ½ inches in length by 1 and ½ inches. Additionally the card may include raised card numbers 302, which reflect the account number associated with the credit/debit card, card holder name 304, expiration data 306 and the like. The card may additionally include issuer information such as the bank or financial institution name 308. A display 310 is provided for visually displaying the dynamically-generated time-dependent passcode 50 (not shown in FIG. 2A). The display includes six digit placements 312 for displaying a six-digit passcode. It should be noted that a six-digit passcode 50 is only exemplary and that other lengths of passcodes are feasible and within the inventive concepts herein disclosed. The card 300 also includes an initiation button 314 that is configured to be addressed by the customer 20 to initiate the generation of the dynamic time-dependent passcode 50.

Referring to FIG. 2B shown is the electronic configuration of the interior of the laminated plastic card 300, in accordance with embodiments of the present invention. The card includes a dynamic passcode generator 40, which may be a microprocessor, such a microprocessor in a standard “smart” card. In place of the general microprocessor, the passcode generator 40 may be included within a dedicated integrated circuit chip, memory chip or other known or future known processing technology. The passcode generator 40 is in electrical communication with a power source 316, such as a built-in battery cell or the like. In addition the passcode generator 40 may in communication with a memory component 318, if the passcode generator 40, itself, does not provide for memory. The memory component 318 is configured to store the algorithm (not shown in FIG. 2B) used to generate the passcode 50.

The initiation button 314, which is included on a facing of the card 300 may include a film capacitance button, which when engaged by the customer 20 generates the dynamic passcode 50. In order to display the passcode 50, passcode generator 40 is in electrical communication with display 310, which may comprise an organic Light Emitting Diode (LED), electroluminescence display, liquid crystal display or other suitable thin, low power display. Additionally, or in lieu of display 310, the passcode generator 40 may be in communication with card speaker 320 which is configured to output an audio signal of the passcode 50. The audio output is typically used in conjunction with a tone reader that recognizes the audio tone output by the card. For example, the customer 20 can initiate the passcode 50 generation and hold the card speaker 320 to the mouthpiece of a smart telephone to log onto a secured system telephonically, so that no other person can listen to the passcode.

Referring to FIG. 3, a flow diagram is presented of a method 400 for express payment transactions with an online merchant using a dynamic time-dependent passcode generator 40, in accordance with embodiments of the present invention. The events of method 400 are depicted in terms of swim-lanes for customer events 402, online merchant events 404 and payment processing entity (i.e., financial institution or the like) events 406. In the illustrated method the customer 20 inputs the dynamically generated passcode 50 and the payment account number to complete the transaction.

The method is initiated at Event 408, at which the customer 20 selects one or more items for purchase at the online merchant and selects the express payment option for conducting the payment process for the selected items. As previously noted each item selection page may include a link button for selecting the express payment option and/or the shopping cart page, showing all items selected, may include the link button for selecting the express payment option. In either instance, once the customer 20 selects the option, the customer 20 is presented with an express payment input page or pop-up window.

At Event 410, the customer 20 engages the dynamic time-dependent passcode generator 40 to generate the dynamic passcode 50. As previously noted the passcode 50 is only valid for a short period of time (e.g., one minute), such that if the period of time elapses the customer will be required to generate another passcode 50. At Event 412, the customer 20 inputs the passcode 50 and the payment account number, such as a debit or credit card number, in the express payment input page or pop-up window. It should be noted that the passcode 50 and the payment account number are the only data inputted by the customer 20.

At Event 414, upon receipt of the customer's express payment inputs, the online merchant communicates a payment request 210 to the payment processing entity. The payment request 210 includes, among other data (such as payment amount and the like), the customer inputted data, i.e., the passcode 50 and the payment account number.

At Event 416, upon receipt of the payment request 210 by the payment processing entity, the transaction/customer is authenticated by verifying that the passcode 50 is the same passcode generated by a synchronized algorithm 212 executing at the payment processing entity. In addition, the transaction is authorized based on transaction amount, payment account standing, payment account limits, other payment account rules and the like. At Event 418, based on transaction/customer authentication and authorization, the customer's personal information is retrieved from a customer profile database 214 or the like. The customer 20 will have preconfigured certain information, such as shipping addresses or the like. In certain embodiments shipping addresses in the customer profile database 214 may be online merchant specific, such that, one shipping address (e.g., the customer's home address) would apply to one or more online merchants while another shipping address (e.g., the customer's work address) would apply to one or more other online merchant's. The customer's personal information may include, but is not limited to, name, shipping address, billing information, address, telephone number(s), email address, age verification and the like. Age verification data may be especially relevant, in that, such information may have been personally verified by the payment processing entity, as opposed to age verification verified based on the truthfulness of the customer 20. As such, the personal information retrieved from the customer's profile will vary depending on the information required by the online merchant to complete the transaction.

At Event 420, transaction authorization and the customer's personal information are communicated to the online merchant and, at Event 422, a check-out confirmation page is displayed to the customer 20 that includes data fields 120 populated with the customer's personal information. At Event 424, the customer will either confirm the personal information as being accurate or make necessary changes to the personal information followed by confirmation. Changes to the personal information may include changes to the shipping address, name or the like. Once the customer 20 confirms the personal information, at Event 426, the transaction is deemed to be completed.

Referring to FIG. 4, a flow diagram is presented of another method 500 for express payment transactions with an online merchant using a dynamic time-dependent passcode generator 40, in accordance with embodiments of the present invention. The events of method 500 are depicted in terms of swim-lanes for customer events 402, online merchant events 404 and payment processing entity (i.e., financial institution or the like) events 406. In the illustrated method, the customer 20 inputs the dynamic passcode 50 and a payment account identifier 114 to complete the transaction.

The method is initiated at Event 508, at which the customer registers or otherwise links a payment account identifier 114 to a payment account. For example, if the payment account identifier 114 is the customer's online or mobile user ID and password, the customer 20 may configure the online or mobile account to link payment accounts to the payment account identifiers 114.

At Event 510, the customer 20 selects one or more items for purchase at the online merchant and selects the express payment option for conducting the payment process for the selected items.

At Event 512, the customer 20 engages the dynamic time-dependent passcode generator 40 to generate the dynamic passcode 50.

At Event 514, the customer 20 inputs the passcode 50 and a payment account identifier 114 in the express payment input page or pop-up window. It should be noted that the passcode 50 and the payment account identifier 114 are the only data inputted by the customer 20. In the illustrated embodiment of the method 500 shown in FIG. 4 the payment account identifier 114 is linked to the payment account and the link is identifiable at the payment processing entity.

At Event 516, upon receipt of the customer's express payment inputs, the online merchant communicates a payment request 210 to the payment processing entity. The payment request 210 includes, among other data (such as payment amount and the like), the customer inputted data, i.e., the passcode 50 and the payment account identifier 114.

At Event 518, upon receipt of the payment request 210 by the payment processing entity, the payment account identifier 114 is correlated to the payment account. For example, in those embodiments in which the payment account identifier 114 is associated with the customer's mobile or online banking account (e.g., the customer's mobile/online banking user ID and password), the customer 20 will have linked a payment account to the payment account identifier 114. The payment processing entity being one in the same or somehow affiliated with the mobile/online bank has the capability to access the customer's mobile/online bank account, via use of the identifier 114 (e.g., user ID and password) to identify the actual payment account. The customer 20 may configure the links such that they are online merchant specific, such that payment to one or more online merchants is accomplished with a first payment account (e.g., checking/debit account) and payment to one or more other online merchants is accomplished with a second payment account (e.g., savings account). It should be noted that in other embodiments of the invention the payment account identifier 114 may be correlated to the payment account at the online merchant prior to communicating the passcode 50 and payment account data to the payment processing entity.

At Event 520, the transaction/customer is authenticated by verifying that the passcode 50 is the same passcode generated by a synchronized algorithm 212 executing at the payment processing entity. In addition, the transaction is authorized based on transaction amount, payment account standing, payment account limits, other payment account rules and the like. At Event 522, based on transaction/customer authentication and authorization, the customer's personal information is retrieved from a customer profile database 214 or the like.

At Event 524, transaction authorization and the customer's personal information are communicated to the online merchant and, at Event 526, a check-out confirmation page is displayed to the customer 20 that includes data fields 120 populated with the customer's personal information. At Event 528, the customer 20 will either confirm the personal information as being accurate or make necessary changes to the personal information followed by confirmation. Changes to the personal information may include changes to the shipping address, name or the like. Once the customer 20 confirms the personal information, at Event 530, the transaction is deemed to be completed.

Referring to FIG. 5, a flow diagram is presented of another method 600 for express payment transactions with an online merchant using a dynamic time-dependent passcode generator 40, in accordance with embodiments of the present invention. The events of method 600 are depicted in terms of swim-lanes for customer events 402, online merchant events 404 and payment processing entity (i.e., financial institution or the like) events 406. In the illustrated method, the customer 20 inputs only the dynamic passcode 50 to complete the transaction.

At Event 608, the method is initiated by the customer 20 selecting one or more items for purchase at the online merchant and selecting the express payment option for conducting the payment process for the selected items.

At Event 610, the customer 20 engages the dynamic time-dependent passcode generator 40 to generate the dynamic passcode.

At Event 612, the customer 20 inputs the passcode 50 in the express payment input page or pop-up window. It should be noted that in such an embodiment the passcode 50 is the only data inputted by the customer 20.

At Event 614, upon receipt of the customer's express payment inputs, the online merchant communicates a payment request 210 to the payment processing entity. The payment request 210 includes, among other data (such as payment amount and the like), the customer inputted data, i.e., the passcode.

At Event 616, upon receipt of the payment request 210 by the payment processing entity, the passcode 50 is correlated to the payment account. In such embodiments of the invention, the passcode 50 may be payment processing entity-specific and be configured such that the passcode 50 itself is able to identify the customer 20 and the customer 20 has preconfigured payment accounts linked to the dynamic passcode.

At Event 618, the transaction/customer is authenticated by verifying that the passcode 50 is the same passcode generated by a synchronized algorithm 212 executing at the payment processing entity. In addition, the transaction is authorized based on transaction amount, payment account standing, payment account limits, other payment account rules and the like. At Event 620, based on transaction/customer authentication and authorization, the customer's personal information is retrieved from a customer profile database 214 or the like.

At Event 622, transaction authorization and the customer's personal information are communicated to the online merchant and, at Event 624, a check-out confirmation page is displayed to the customer 20 that includes data fields 120 populated with the customer's personal information. At Event 626, the customer 20 will either confirm the personal information as being accurate or make necessary changes to the personal information followed by confirmation. Changes to the personal information may include changes to the shipping address, name or the like. Once the customer 20 confirms the personal information, at Event 628, the transaction is deemed to be completed.

Referring to FIG. 6, a flow diagram is presented of another method 700 for express payment transactions with an online merchant using a dynamic time-dependent passcode generator 40 in accordance with embodiments of the present invention. The events of method 700 are depicted in terms of swim-lanes for customer events 402, online merchant events 404 and payment processing entity (i.e., financial institution or the like) events 406. In the illustrated method, unlike previously described embodiments, the customer 20 has registered an account with the online merchant and is only required to input the dynamic passcode 50 to complete the transaction.

At Event 708, the customer 20 creates an online merchant account with the online merchant and registers/links a payment account to the express payment option. At Event, 710, prior to selecting the express payment option, the customer 20 logs-in to their online merchant account.

At Event 712, the customer 20 selects one or more items for purchase at the online merchant and selects the express payment option for conducting the payment process for the selected items. At Event 714, the customer 20 engages the dynamic time-dependent passcode generator 40 to generate the dynamic passcode 50 and, at Event 716, the customer 20 inputs the passcode 50 in the express payment input page or pop-up window. It should be noted that in such an embodiment the passcode 50 is the only data inputted by the customer 20.

At Event 718, upon receipt of the customer's express payment inputs, the online merchant retrieves the payment account number associated with the customer's online merchant account and, at Event 720, the online merchant communicates a payment request 210 to the payment processing entity. The payment request 210 includes, among other data (such as payment amount and the like), the customer inputted data, i.e., the passcode and the payment account number.

At Event 722, upon receipt of the payment request 210 by the payment processing entity, the transaction/customer is authenticated by verifying that the passcode 50 is the same passcode generated by a synchronized algorithm 212 executing at the payment processing entity. In addition, the transaction is authorized based on transaction amount, payment account standing, payment account limits, other payment account rules and the like. At Event 724, based on transaction/customer authentication and authorization, the customer's personal information is retrieved from a customer profile database 214 or the like.

At Event 726, transaction authorization and the customer's personal information are communicated to the online merchant and, at Event 728, a check-out confirmation page is displayed to the customer 20 that includes data fields 120 populated with the customer's personal information. At Event 730, the customer 20 will either confirm the personal information as being accurate or make necessary changes to the personal information followed by confirmation. Changes to the personal information may include changes to the shipping address, name or the like. Once the customer 20 confirms the personal information, at Event 732, the transaction is deemed to be completed.

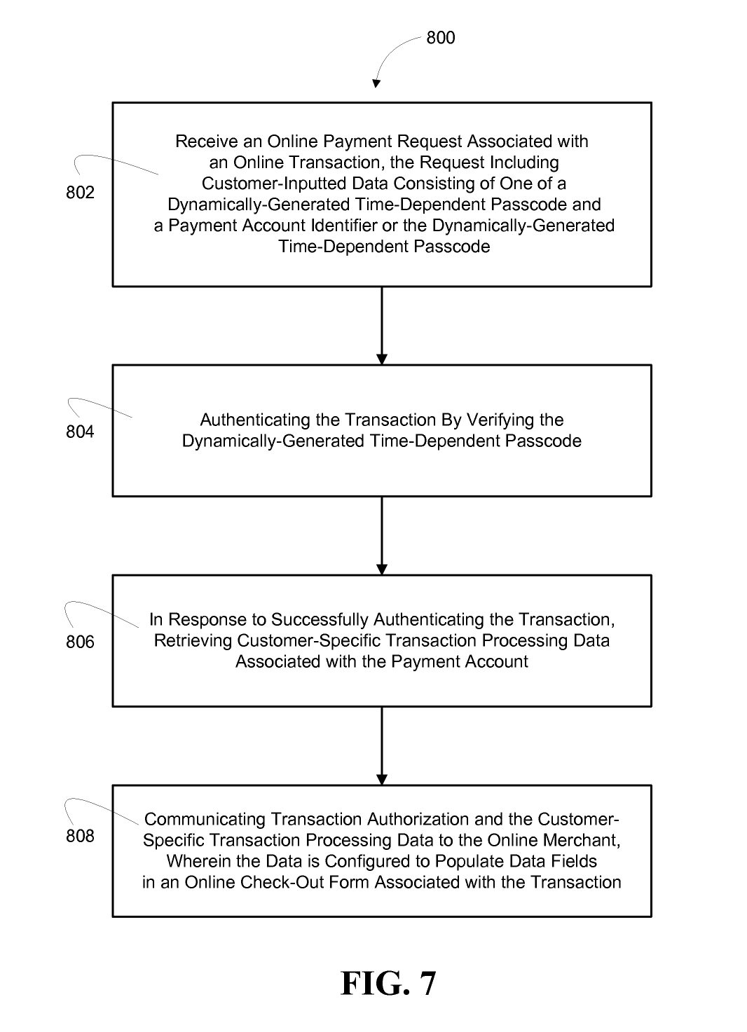

Turning the reader's attention to FIG. 7 a flow diagram is shown of a method 800 for payment processing of payment requests associated with online express payment, in accordance with embodiments of the present invention. At Event 802, an online payment request 210 associated with an online transaction is received by a payment processing entity, such as a financial institution or the like. The payment request 210 includes customer-inputted data, which consists of one of (1) a dynamically-generated time-dependent passcode 50 and a payment account identifier 114 or (2) the dynamically-generated time-dependent passcode. In this regard either the dynamically-generated time-dependent passcode 50 and a payment account identifier 114 or the dynamically-generated time-dependent passcode 50 are the only data required to be inputted by the customer 20 to complete the transaction.

The payment account identifier 114 may be the payment account number, such as a credit/debit account number, or another identifier linked to the payment account, such as a user ID and password associated with a mobile or online banking account or, in specific embodiments, an online merchant account.

At Event 804, the transaction/customer is authenticated by verifying the passcode 50 as being valid. Such authentication includes comparing the customer passcode 50 to a passcode generated by a synchronized algorithm 212 executing at the payment processing entity to insure that the two passcodes are the same.

At Event 806, in response to successfully authenticating the transaction, retrieving customer-specific transaction processing data 216 associated with the customer 20 and payment account. As previously noted, the information retrieved may be online merchant-specific, payment account-specific and may include, but is not limited to, name, shipping address, billing address/information, email address, telephone number(s), age verification and the like.

At Event 808, transaction authorization and the customer-specific transaction processing data 216 is communicated to the online merchant. The data is configured to populate data fields 120 in an online check-out form associated with the transaction, such that the customer 20, presented with the populated data entries in the form, can confirm the data or make necessary changes to complete the transaction.

Thus, systems, methods, and computer program products herein described provide for a high velocity means for conducting online payment of merchant transaction. High velocity simplistic approach to online payment is realized by limiting the amount of information that is needed to be inputted by the customer 20 and having the payment providing entity, such as a financial institution or the like, supply the needed customer information, such as the customer name, shipping address, billing information and the like. In accordance with embodiments of the invention. The requisite customer inputted data is limited to the dynamic time-dependent passcode 50 and, in some embodiments, the payment account identifier 114. In addition to realizing high velocity transactions, the present invention results in a higher level of security being afforded the customer 20 because actual possession of the device generating the dynamic passcode 50 and the payment account identifier 114 are needed to conduct a transaction. Moreover, the online merchant benefits from the payment processing entity providing the online merchant with vetted customer information, thereby, insuring that the shipping information is accurate.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for processing an online transaction conducted with an online merchant, the method comprising:
receiving, by a computing device, an online payment request associated with the transaction, wherein the request includes customer-inputted data consisting of a dynamically-generated time-dependent passcode;
authenticating, by a computing device processor, the transaction by verifying the dynamically-generated time-dependent passcode;
in response to successfully authenticating the transaction, retrieving, by a computing device processor, customer-specific transaction processing data associated with a payment account; and
communicating, by a computing device processor, transaction authorization and the customer-specific transaction processing data to the online merchant, wherein the customer-specific transaction processing data is configured to populate data fields in an online check-out form associated with the transaction.

2. The method of claim 1, wherein receiving further comprises receiving, by the computing device, the online payment request including the customer-inputted data consisting of a payment account identifier and the dynamically-generated time-dependent passcode.

3. The method of claim 2, wherein receiving further comprises receiving, by the computing device, the online payment request including the customer-inputted data consisting of the payment account identifier and the dynamically-generated time-dependent passcode, wherein the payment account identifier is one of a credit card number or a debit card number.

4. The method of claim 2, wherein receiving further comprises receiving, by the computing device, the online payment request including the customer-inputted data consisting of the payment account identifier and the dynamically-generated time-dependent passcode, wherein the payment account identifier is at least one of a username or a password.

5. The method of claim 4, wherein receiving further comprises receiving, by the computing device, the online payment request including the customer-inputted data consisting of the payment account identifier and the dynamically-generated time-dependent passcode, wherein the payment account identifier is at least one of the username or the password, wherein the username, the password or both are linked to the payment account.

6. The method of claim 4, wherein receiving further comprises receiving, by the computing device, the online payment request including the customer-inputted data consisting of the payment account identifier and the dynamically-generated time-dependent passcode, wherein the payment account identifier is at least one of the username or the password, wherein the username, password or both are associated with a customer account at the online merchant and the customer account provides for the payment account.

7. The method of claim 4, wherein receiving further comprises receiving, by the computing device, the online payment request including the customer-inputted data consisting of the payment account identifier and the dynamically-generated time-dependent passcode, wherein the payment account identifier is at least one of a user name or a password, wherein the username, the password or both are associated with a mobile banking service account that provides for the payment account.

8. The method of claim 1, wherein receiving further comprises receiving, by the computing device processor, the customer-specific transaction processing data, wherein the data includes at least a customer name, a shipping address and a billing address.

9. A system for processing an online transaction conducted with an online merchant, the system comprising:
a dynamic passcode generator device configured to generate a dynamic time-dependent passcode;
a computing device including a memory and a processor;
a payment processing module stored in the memory, executable by the processor and configured to:
receive an online payment request including customer-inputted data consisting of the dynamic time-dependent passcode,
authenticate the transaction by verifying the dynamically-generated time-dependent passcode;
in response to successfully authenticating the transaction, retrieve customer-specific transaction processing data associated with a payment account, and
communicate transaction authorization and the customer-specific transaction processing data to the online merchant, wherein the customer-specific transaction processing data is configured to populate data fields in an online check-out form associated with the transaction.

10. The system of claim 9, wherein the payment processing module is further configured to receive the online payment request including the customer-inputted data consisting of a payment account identifier and the dynamically-generated time-dependent passcode.

11. The system of claim 10, wherein the payment processing module is further configured to receive the online payment request including the customer-inputted data consisting of the payment account identifier and the dynamically-generated time-dependent passcode, wherein the payment account identifier is one of a credit card number or a debit card number.

12. The system of claim 10, wherein the payment processing module is further configured to receive the online payment request including the customer-inputted data consisting of a payment account identifier and the dynamically-generated time-dependent passcode, wherein the payment account identifier is at least one of a username or a password.

13. The system of claim 12, wherein the payment processing module is further configured to receive the online payment request including the customer-inputted data consisting of a payment account identifier and the dynamically-generated time-dependent passcode, wherein the payment account identifier is at least one of a username or a password, wherein the username, the password or both are linked to the payment account.

14. The system of claim 12, wherein the payment processing module is further configured to receive the online payment request including the customer-inputted data consisting of a payment account identifier and the dynamically-generated time-dependent passcode, wherein the payment account identifier is at least one of a username or a password, wherein the username, password or both are associated with a customer account at the online merchant and the customer account provides for the payment account.

15. The system of claim 12, wherein the payment processing module is further configured to receive the online payment request including the customer-inputted data consisting of a payment account identifier and the dynamically-generated time-dependent passcode, wherein the payment account identifier is at least one of a username or a password, wherein the user, the password or both are associated with a mobile banking service account that provides for the payment account.

16. The system of claim 1, wherein receiving further comprises receiving, by the computing device processor, the customer-specific transaction processing data, wherein the data includes at least a customer name, a shipping address and a billing address.

17. The system of claim 1, wherein the dynamic passcode generator device is embedded within a plastic card.

18. The system of claim 1, wherein the dynamic passcode generator device is a security token.

19. A computer program product, the computer program product comprising a non-transitory computer-readable medium having computer-executable instructions to cause a computer to implement the steps of:
receiving an online payment request associated with the transaction, wherein the request includes customer-inputted data consisting of a dynamically-generated time-dependent passcode;
authenticating the transaction by verifying the dynamically-generated time-dependent passcode;
in response to successfully authenticating the transaction, retrieving customer-specific transaction processing data associated with a payment account; and
communicating transaction authorization and the customer-specific transaction processing data to the online merchant, wherein the customer-specific transaction processing data is configured to populate data fields in an online check-out form associated with the transaction.

20. The computer program product of claim 19, wherein the step of receiving further comprises receiving the online payment request including the customer-inputted data consisting of a payment account identifier and the dynamically-generated time-dependent passcode.

21. The computer program product of claim 20, wherein the step of receiving further comprises receiving the online payment request including the customer-inputted data consisting of the payment account identifier and the dynamically-generated time-dependent passcode, wherein the payment account identifier is one of a credit card number or a debit card number.

22. The computer program product of claim 20, wherein the step of receiving further comprises receiving the online payment request including the customer-inputted data consisting of the payment account identifier and the dynamically-generated time-dependent passcode, wherein the payment account identifier is at least one of a username or a password.

23. The computer program product of claim 22, wherein the step of receiving further comprises receiving the online payment request including the customer-inputted data consisting of the payment account identifier and the dynamically-generated time-dependent passcode, wherein the payment account identifier is at least one of the username or the password, wherein the username, the password or both are linked to the payment account.

24. The computer program product of claim 22, wherein the step of receiving further comprises receiving the online payment request including the customer-inputted data consisting of the payment account identifier and the dynamically-generated time-dependent passcode, wherein the payment account identifier is at least one of the username or the password, wherein the username, password or both are associated with a customer account at the online merchant and the customer account provides for the payment account.

25. The computer program product of claim 22, wherein the step of receiving further comprises receiving the online payment request including the customer-inputted data consisting of the payment account identifier and the dynamically-generated time-dependent passcode, wherein the payment account identifier is at least one of a user name or a password, wherein the user, the password or both are associated with a mobile banking service account that provides for the payment account.

26. The computer program product of claim 19, wherein the step of retrieving further comprises retrieving the customer-specific transaction processing data, wherein the data includes at least a customer name, a shipping address and a billing address.
